(19) United States
(12) Patent Application Publication
(10) Pub. No.: US 2023/0096624 A1
(43) Pub. Date: Mar. 30, 2023

(54) AUTOMATED INVENTORY MANAGEMENT SYSTEM

(71) Applicant: Grey Orange Inc., Roswell, GA (US)

(72) Inventor: Vipin SHARMA, Gurgaon (IN)

(73) Assignee: Grey Orange Inc., Roswell, GA (US)

(21) Appl. No.: 17/535,893

(22) Filed: Nov. 26, 2021

(30) Foreign Application Priority Data
Sep. 29, 2021 (IN) 202121044254

(51) Int. Cl. B65G 1/04; B65G 1/137; G06Q 10/08

(52) U.S. Cl. CPC B65G 1/0492; B65G 1/1373; G06Q 10/087

(57) ABSTRACT

An inventory management system comprising at least one storage unit, first and second robotic apparatus, and a control server. The control server receives a handling request for handling one or more inventory items stored in the storage unit and communicates a first set of instructions to first robotic apparatus to cause the first robotic apparatus to transport the storage unit from an inventory storage area to a processing area. The control server further communicates a second set of instructions to second robotic apparatus to cause the second robotic apparatus to receive the inventory items and transport the received inventory items to an operation area. The control server further communicates a third set of instructions to the second robotic apparatus to cause the second robotic apparatus to align with an identified target platform for transferring the transported inventory items to the identified target platform.

### CROSS-RELATED APPLICATIONS

This application claims priority of Indian Provisional Application No. 202121044254, filed Sep. 29, 2021, the contents of which are incorporated herein by reference.

### FIELD OF THE DISCLOSURE

Various embodiments of the disclosure relate generally to inventory management systems. More specifically, various embodiments of the disclosure relate to methods and systems for automated inventory management in a storage facility.

### BACKGROUND

Inventory storage facilities receive numerous order fulfilment requests, inventory replenishment requests, or the like on a daily basis. The inventory storage facilities face significant challenges in responding to such requests (e.g., orders fulfilment requests, inventory replenishment requests, or the like) as they involve manual intervention for handling inventory items. Therefore, the inventory storage facilities may exhibit inefficient utilization of resources while responding to such requests. Consequently, the inventory storage facilities may face lower throughput, long response times, increasing backlog of unfulfilled requests, and generally below par system performance. Also, expanding or reducing size or capabilities of inventory storage facilities requires changes to existing infrastructure and equipment. Hence, incremental changes in capacity and/or functionality may be cost-intensive, and thereby may limit the ability of the inventory storage facilities to accommodate changes (increase or decrease) in throughput.

In light of the foregoing, there exists a need for a technical solution that overcomes the abovementioned problems and provides a reliable solution for efficient management of inventory storage facilities.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

Inventory management systems and Methods for inventory management are provided substantially as shown in, and described in connection with, at least one of the figures, as set forth more completely in the claims. The inventory management system may include at least one storage unit that stores a plurality of inventory items and has a corresponding resting position in an inventory storage area of a storage facility. The system may further include a first robotic apparatus that may be remotely controllable to transport the at least one storage unit between the inventory storage area and a processing area of the storage facility. The first set of pick/put operations are executed in the processing area to handle one or more inventory items of the plurality of inventory items. The system may further include a second robotic apparatus that may be remotely controllable to transport the handled one or more inventory items between the processing area and an operation area. The operation area has one or more platforms to receive the one or more inventory items transported by the second robotic apparatus. The system may further include a control server. The control server may be in communication with the first and second robotic apparatus. The control server may be configured to receive at least one handling request for handling the one or more inventory items. The control server may be further configured to communicate a first set of instructions to the first robotic apparatus to cause the first robotic apparatus to transport the at least one storage unit that has the one or more inventory items stored therein from the inventory storage area to the processing area. The first robotic apparatus may be configured to transport the at least one storage unit from the inventory storage area to the processing area based on the first set of instructions. The control server may be further configured to communicate a second set of instructions to the second robotic apparatus to cause the second robotic apparatus to receive the one or more inventory items handled in the processing area and transport the received one or more inventory items to the operation area. Based on the second set of instructions, the second robotic apparatus may be configured to transport the one or more inventory items to the operation area and identify at least one target platform from the one or more platforms of the operation area to transfer the one or more inventory items. The control server may be further configured to communicate a third set of instructions to the second robotic apparatus to cause the second robotic apparatus to align with the identified at least one target platform for transferring the transported one or more inventory items to the identified at least one target platform.

In an embodiment, the at least one storage unit may include a plurality of shelves that store the plurality of inventory items. In an embodiment, a height of each shelf of the plurality of shelves of the at least one storage unit may be adjustable so as to align each shelf with an access position of the at least one storage unit. In an embodiment, the first robotic apparatus may be further configured to adjust a height of a first shelf of the plurality of shelves so as to align the first shelf with the access position based on the first set of instructions. The one or more inventory items that are to be handled may be stored on the first shelf.

In an embodiment, the at least one storage unit may further include a first drive mechanism coupled with the plurality of shelves. When actuated, the first drive mechanism may move the plurality of shelves so as to align at least the first shelf of the plurality of shelves with respect to the access position. In an embodiment, the first robotic apparatus may be further configured to actuate the first drive mechanism based on the first set of instructions. The first robotic apparatus may include an actuator mechanism that may be configured to actuate the first drive mechanism based on the first set of instructions.

In an embodiment, the second robotic apparatus may include a plurality of levels. Each level of the plurality of levels may include at least one conveyor. The one or more inventory items may be received by the second robotic apparatus on a top surface of a conveyor of a target level of the plurality of levels of the second robotic apparatus. In an embodiment, the one or more inventory items may be received by the at least one target platform based on a rotation of the conveyor of the target level.

In an embodiment, the processing area may further include a plurality of visual indicators that when aligned with the plurality of levels of the second robotic apparatus may be configured to provide a visual indication of the target level of the plurality of levels at which the one or more inventory items are to be received by the second robotic apparatus.

In an embodiment, a height of each level of the plurality of levels of the second robotic apparatus may be adjustable so as to align the target level with the at least one target platform to transfer the one or more inventory items to the at least one target platform.

In an embodiment, each level of the plurality of levels of the second robotic apparatus may have corresponding physical attributes. The physical attributes may include a count of conveyor, weight bearing capacity, inventory item dimension that could be handled, size of the conveyor, of each level of the plurality of levels.

In an embodiment, the second robotic apparatus may further include a second drive mechanism coupled to the plurality of levels. When actuated, the second drive mechanism may move the plurality of levels so as to align the target level with the at least one target platform to transfer the one or more inventory items to the at least one target platform.

In an embodiment, the first robotic apparatus may be further configured to transport the at least one storage unit from the processing area to the inventory storage area based on the first set of instructions. The first robotic apparatus may transport the at least one storage unit from the processing area to the inventory storage area after the first set of pick/put operations are executed on the one or more inventory items at the processing area.

In an embodiment, the second robotic apparatus may be further configured to transport at least one new inventory item from the operation area to the processing area based on a fourth set of instructions. The second robotic apparatus may transport the at least one new inventory item to the processing area for execution of a second set of pick/put operations for handling the at least one new inventory item.

In an embodiment, the operation area may be one of a defective item collection area, an order consolidation area, a quality check area, and the inventory storage area.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary environment of a storage facility, in accordance with an exemplary embodiment of the disclosure;

FIG. 2 is a schematic diagram that illustrates a storage unit, in accordance with an exemplary embodiment of the disclosure;

FIG. 3 is a schematic diagram that illustrates a first robotic apparatus, in accordance with an exemplary embodiment of the disclosure;

FIG. 4 is a schematic diagram that illustrates an exemplary scenario of engagement between the storage unit and the first robotic apparatus, in accordance with an exemplary embodiment of the disclosure;

FIG. 5 is a schematic diagram that illustrates a second robotic apparatus, in accordance with an exemplary embodiment of the disclosure;

FIG. 6 is a block diagram that illustrates a control server, in accordance with an exemplary embodiment of the disclosure;

FIGS. 7A-7E are schematic diagrams that illustrate an exemplary scenario of implementation of an automated inventory management system, in accordance with an exemplary embodiment of the disclosure;

FIG. 8 a block diagram that illustrates a system architecture of a computer system for inventory management, in accordance with an exemplary embodiment of the disclosure; and

FIG. 9 is a flowchart that illustrates a process for inventory management, in accordance with an exemplary embodiment of the disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Certain embodiments of the disclosure may be found in the disclosed systems and methods for inventory management in a storage facility. Exemplary aspects of the disclosure provide inventory management systems and methods for inventory management.

The methods and systems of the disclosure provide a solution for automated handling and transportation of inventory items within the storage facility. The methods and systems disclosed herein facilitate inventory management with significantly reduced human intervention. Also, the methods and systems disclosed herein significantly reduce time-consumption in manual intervention required for transporting and handling of the inventory items, and hence increases a throughput and productivity of the storage facility.

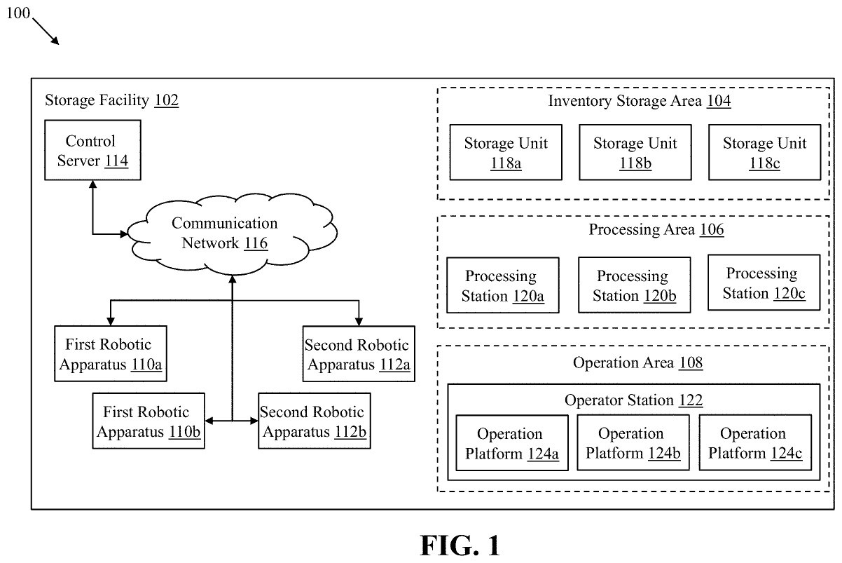

FIG. 1 is a block diagram that illustrates an exemplary environment 100 of a storage facility 102, in accordance with an exemplary embodiment of the disclosure. Referring to FIG. 1, the storage facility 102 may include an inventory storage area 104, a processing area 106, an operation area 108, a plurality of first robotic apparatus 110a-110b (hereinafter, collectively referred to and designated as “the first robotic apparatus 110”), a plurality of second robotic apparatus 112a-112b (hereinafter, collectively referred to and designated as “the second robotic apparatus 112”), and a control server 114. The control server 114 may be configured to communicate with the first and second robotic apparatus 110 and 112 by way of a communication network 116 or via separate communication networks established therebetween. The communication network 116 is a medium through which instructions and messages are transmitted between the first and second robotic apparatus 110 and 112 and the control server 114. Examples of the communication network 116 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities (such as the first and second robotic apparatus 110 and 112 and the control server 114) in the storage facility 102 may be coupled to the communication network 116 in accordance with various wired and wireless communication protocols, such as Transmission Control Protocol and Internet Protocol (TCP/IP), User Datagram Protocol (UDP), Long Term Evolution (LTE) communication protocols, or any combination thereof.

The storage facility 102 is a facility where inventory items or packages of inventory items are stored for order fulfillment and/or selling. Examples of the storage facility 102 may include, but are not limited to, a forward warehouse, a backward warehouse, a fulfillment center, or a retail store (e.g., a supermarket, an apparel store, a departmental store, a grocery store, or the like). Examples of the inventory items may include, but are not limited to, groceries, apparels, electronic goods, mechanical goods, or the like. The storage facility 102 has the inventory storage area 104 where a plurality of storage units 118a-118c (hereinafter, collectively referred to and designated as “the storage units 118”) are placed for storing the inventory items and/or the packages. In some embodiments, the inventory storage area 104 may be a resting place for one or more robotic apparatus (for example, first and second robotic apparatus 110 and 112). The storage units 118 may be arranged in the inventory storage area 104 in any arrangement that may be optimal for storage and retrieval of the storage units 118 as well as the inventory items stored therein. Various plans for arrangement of the storage units 118 within the inventory storage area 104 may be known in the art. Arrangement of the storage units 118 in the inventory storage area 104 may be automatic, semi-automatic, or manual. Storage of the inventory items in the storage units 118 may be automatic, semi-automatic, or manual.

The storage units 118, stored in the inventory storage area 104, are structures (racks, bins, or the like) for storing various inventory items and/or various packages. Each of the storage units 118 may include a plurality of shelves, which enable the corresponding storage unit to store multiple inventory items or packages. Each shelf of the plurality of shelves may have different size and weight bearing capacity. Each of the storage units 118 may have a different structure, storage capacity, dimensions, weight bearing capacity, size, shape, or the like. The storage units 118 are transported by the first robotic apparatus 110 within the storage facility 102 i.e., between the inventory storage area 104 and the processing area 106 or the operation area 108 for order fulfillment or replenishment of the inventory items. In some embodiments, the first robotic apparatus 110 may transport one or more storage bins having the inventory items. In some embodiments, the storage units 118 transported by the first robotic apparatus 110 may have the one or more storage bins stored on corresponding shelves.

Further, each of the storage units 118 may include a reference marker attached to or formed on a bottom surface (i.e., a surface that faces a work floor) for uniquely identifying the corresponding storage unit. Examples of the reference marker may include, but are not limited to, a barcode, a quick response (QR) code, a radio frequency identification device (RFID) tag, or the like. It will be apparent to those of skill in the art that the storage units 118 may further include additional structural features that aid in carrying or otherwise transporting the storage units 118, without deviating from the scope of the disclosure.

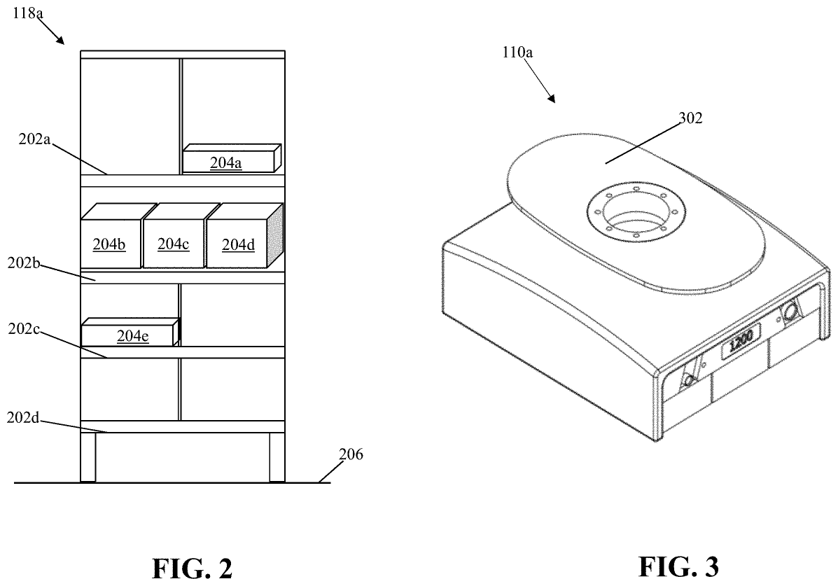

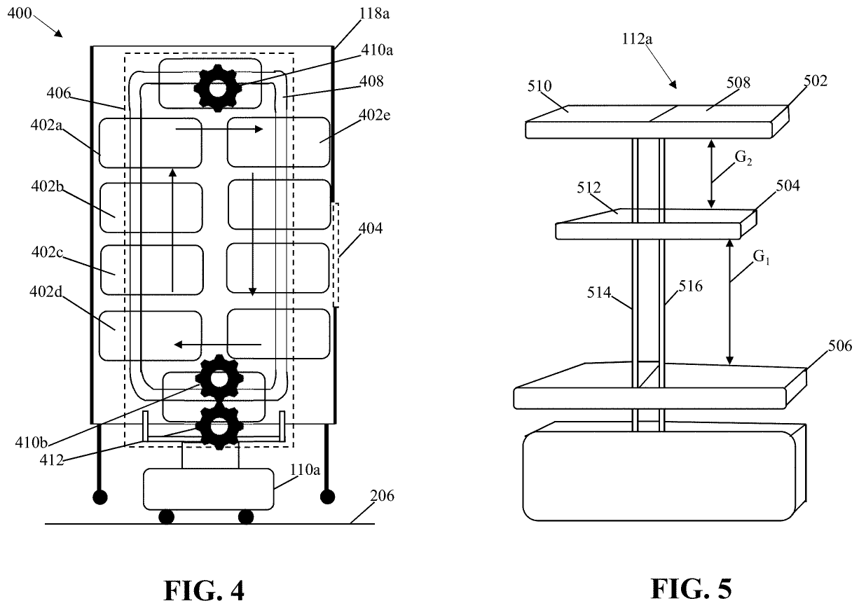

In an embodiment, each of the storage units 118 may have an access position. The access position may refer to an opening or a portion of the storage units 118 from where the inventory items stored on the plurality of shelves may be accessed by corresponding operators. In such an embodiment, the plurality of shelves of the storage units 118 may be movable so as to align with the access position. The storage units 118 are described in detail in conjunction with FIG. 2. The movement of the plurality of shelves of a storage unit (e.g., one of the storage units 118) to align with a corresponding access position is described in detail in conjunction with FIG. 4.

The storage facility 102 further includes the processing area 106 that refers to a portion of the storage facility 102 where one or more pick/put operations are performed for handling the inventory items. The processing area 106 may have a plurality of processing stations 120a-120c (hereinafter, collectively referred to and designated as “the processing stations 120”) for executing the pick/put operations on the inventory items. The processing stations 120 may be associated with corresponding operators assigned to perform the pick/put operations. In an embodiment, the processing stations 120 may also have corresponding automated guided vehicles (AGVs) or robotic apparatus for performing the pick/put operations on the inventory items. The pick/put operations may be performed at the processing stations 120 for order fulfillment, inventory replenishment, damaged goods collection, quality check, or the like. Each of the processing stations 120 may have a user interface for presenting one or more instructions to the assigned operators for handling the inventory items. The processing stations 120 may further include one or more optical sensors that may be configured to capture one or more images or videos to monitor the pick/put operations, alignment and positioning of the inventory items being handled, state of the inventory items, or the like. In an embodiment, the processing area 106 or the processing stations 120 may be resting locations for the one or more robotic apparatus (for example, the first and second robotic apparatus 110 and 112).

In some embodiments, when the processing stations 120 may include the user interface (e.g., a human machine interface), the user interface may receive various commands or instructions from the control server 114 for retrieval of the inventory items from the storage units 118. Based on the received commands or instructions, corresponding operator may retrieve the inventory items from the storage units 118. The inventory items may be handled at the processing stations 120 by execution of a first set of pick/put operations by corresponding operators. In some embodiments, an item retrieval operation at a processing station (e.g., the processing stations 120) may involve batch picking of multiple units of an inventory item from a storage unit (e.g., the storage units 118) and placing the picked units of the inventory items on one or more of the second robotic apparatus 112 or a temporary storage bin at one of the processing stations 120.

The inventory items may be transported between the inventory storage area 104 and the processing area 106 by the first robotic apparatus 110. The first robotic apparatus 110 may refer to transport vehicles used in the storage facility 102 for lifting and transporting the storage units 118. The first robotic apparatus 110 may be configured to communicate with the control server 114. The first robotic apparatus 110 may be remotely controllable by the control server 114 to transport the storage units 118 between the inventory storage area 104 and the processing area 106 of the storage facility 102. The first robotic apparatus 110 may vary in terms of dimensions, weight lifting capability, size, shape, or the like. Each first robotic apparatus 110 may include one or more means and arrangements for lifting, securing, and transporting the storage units 118. The first robotic apparatus 110 are described in detail in conjunction with FIG. 3.

The storage facility 102 further includes the operation area 108. The operation area 108 may have one or more operation stations (for example, an operation station 122). In some embodiments, the operation area 108 may refer to a portion within the storage facility 102 where inventory items are consolidated and leave the storage facility 102 for order fulfillment, new inventory items are received for inventory replenishment, damaged inventory items are identified and collected, or the like. In some embodiments, the operation area 108 may also include one or more processing stations for performing pick-put operations for order consolidation, damaged inventory collection, quality checks, or the like.

The operation station 122 may have a plurality of operation platforms 124a-124c (hereinafter, collectively referred to and designated as “the operation platforms 124”). The operation station 122 is placed in the operation area 108 for receiving the inventory items either from the processing area 106 or from an external portion of the storage facility 102 from where the new inventory items enter the storage facility 102. The operation station 122 receives the inventory items at one of the operation platforms 124. Though the operation area 108 is shown to include a single operator station (e.g., the operation station 122), in other embodiments the operation area 108 may include a plurality of operation stations.

In an embodiment, the operation area 108 may be one of a defective item collection area, an order consolidation area, a quality check area, the inventory storage area 104, and/or the processing area 106. In an exemplary scenario, where the operation area 108 may be the defective item collection area, the operation platforms 124 may receive one or more inventory items that may have been categorized as damaged inventory items at the processing stations 120. In another exemplary scenario, where the operation area 108 may be the order consolidation area, the operation platforms 124 may receive one or more inventory items for consolidation to fulfil one or more orders received by the storage facility 102. In another exemplary scenario, where the operation area 108 may be the quality check area, the operation platforms 124 may receive the one or more inventory items for a quality check. In another exemplary scenario, where the operation area 108 may be the inventory storage area 104, the operation platforms 124 may receive the one or more inventory items for storage. In such a scenario, the operation platforms 124 may serve as the storage units 118. In another exemplary scenario, the inventory items received by the operation platforms 124 may be handled by at least one of the first robotic apparatus 110, the second robotic apparatus 112, or an operator associated with the operation platforms 124 to store the inventory items in the storage units 118.

The inventory storage area 104, the processing area 106, and the operation area 108 may be of any shape, for example, a rectangular shape, a square shape, a combination of different geometrical shape structures, or the like. In one embodiment, the storage units 118 in the inventory storage area 104, the processing stations 120 in the processing area 106, and the operation stations in the operation area 108 may be arranged to form aisles therebetween. Arrangement of the storage units 118, the processing stations 120, and the operation stations is a standard practice and will be apparent to those of skill in the art.

Further, transportation of the inventory items handled at the processing stations 120 to the operation station 122 may be performed by the second robotic apparatus 112. The second robotic apparatus 112 may be structurally and functionally different from the first robotic apparatus 110. The second robotic apparatus 112 may be configured to receive the inventory items handled at the processing stations 120. In some embodiments, the second robotic apparatus 112 may receive the inventory items in one or more storage bins. In such embodiments, the second robotic apparatus 112 may transport the one or more storage bins having the inventory items from the processing stations 120 to the operation station 122. The second robotic apparatus 112 may be communicatively coupled to the control server 114 and may be remotely controllable by the control server 114 to transport the inventory items between the processing area 106 and the operation area 108. Each second robotic apparatus 112 may have a plurality of levels. Each level of the plurality of levels may have one or more conveyors for receiving the inventory items handled at the processing stations 120. Further, each level of the plurality of levels may have corresponding physical attributes. The physical attributes of each level of the plurality of levels may refer to one or more factors that may affect one or more operations to be performed by the second robotic apparatus 112 for transporting the inventory items between the processing area 106 and the operation area 108. The physical attributes may include a count of conveyors, weight bearing capacity, inventory item dimension that could be handled, and a size of the conveyors, of each level of the plurality of levels. The physical attributes of each level of the plurality of levels are described in detail in conjunction with FIG. 5.

Transportation of the storage units 118 between the inventory storage area 104 and the processing area 106 by the first robotic apparatus 110 and transportation of the inventory items handled in the processing area 106 to the operation area 108 by the second robotic apparatus 112 may be controlled by the control server 114. The storage facility 102 may include a plurality of fiducial markers that may be indicative of corresponding locations within the storage facility 102. The fiducial markers may be followed by the first robotic apparatus 110 and the second robotic apparatus 112 to transport the inventory items between the inventory storage area 104 and the processing area 106 and between the processing area 106 and the operation area 108, respectively. The control server 114 may include suitable logic, circuitry, interfaces, and/or code, executable by the circuitry, to facilitate various inventory management operations in the storage facility 102. Examples of the control server 114 may include, but are not limited to, personal computers, laptops, mini-computers, mainframe computers, any non-transient and tangible machine that can execute a machine-readable code, cloud-based servers, distributed server networks, or a network of computer systems. The control server 114 may be realized through various web-based technologies such as, but not limited to, a Java web-framework, a .NET framework, a personal home page (PHP) framework, or any other web-application framework. The control server 114 may be maintained by a storage facility management authority or a third-party entity that facilitates inventory management and handling operations for the storage facility 102. It will be understood by a person having ordinary skill in the art that the control server 114 may execute other storage facility management operations as well along with the inventory management operations.

The control server 114 may be configured to communicate with the first and second robotic apparatus 110 and 112. The control server 114 may be further configured to remotely control the first and second robotic apparatus 110 and 112. The control server 114 may be further configured to store, in a memory of the control server 114, a virtual map of the storage facility 102 and inventory storage data of inventory stock. The virtual map is indicative of a current location of the first and second robotic apparatus 110 and 112, entry and exit points of the storage facility 102, various reference markers in the storage facility 102, a current location of each inventory item, a current location of each storage unit 118, locations of the processing stations 120, locations of the operation stations, or the like. The inventory storage data is indicative of associations between the inventory items stored in the storage facility 102 and the storage units 118 in the storage facility 102. The inventory storage data may further include historic storage locations of each inventory item. The inventory storage data further includes parameters (for example, weight, shape, size, color, dimensions, or the like) associated with each inventory item.

For the sake of brevity, the ongoing description is described with respect to the storage unit 118a, the first robotic apparatus 110a, the processing station 120a, the second robotic apparatus 112a, and the operation platform 124a.

In an embodiment, the control server 114 may be configured to receive a handling request for handling an inventory item. The control server 114 may be further configured to determine a storage unit (for example, the storage unit 118a) that may have the inventory item that is to be handled. The control server 114 may be further configured to identify a first robotic apparatus (for example, the first robotic apparatus 110a) from the first robotic apparatus 110 that may be available for transporting the storage unit 118a that may have the inventory item. Subsequently, the control server 114 may be configured to communicate a first set of instructions to the first robotic apparatus 110a.

The first set of instructions may include a path to be followed by the first robotic apparatus 110a to reach the storage unit 118a, an identifier of the storage unit 118a, and a path to be followed to reach the processing station 120a after lifting the storage unit 118a. The first set of instructions may cause the first robotic apparatus 110a to transport the storage unit 118a from the inventory storage area 104 to the processing station 120a in the processing area 106. In other words, the first robotic apparatus 110a may transport the inventory item to the processing station 120a where a first set of pick/put operations for handling the inventory item may be executed on the inventory item. The first set of pick/put operations may include picking the inventory item from a corresponding shelf of the storage unit 118a and putting the inventory item on a target level of one of the second robotic apparatus 112 available at the processing station 120a. In some embodiments, the first robotic apparatus 110a may transport the one or more storage bins having the inventory item to the processing station 120a. In such embodiments, the first set of pick/put operations may include picking the one or more storage bins having the inventory item and putting the one or more storage bins on a target level of one of the second robotic apparatus 112 available at the processing station 120a.

In some embodiments, the first robotic apparatus 110a may be an automated robotic vehicle that may pick the inventory item from corresponding shelf of the storage unit 118a. In such an embodiment, the first robotic apparatus 110a may transport the inventory item to the processing station 120a where the first set of pick/put operations may be performed for handling the inventory item.

The control server 114 may be further configured to identify a second robotic apparatus (for example, the second robotic apparatus 112a) from the second robotic apparatus 112 that may be available for transporting the inventory item handled at the processing station 120a to the operation area 108. Subsequently, the control server 114 may be configured to communicate a second set of instructions to the second robotic apparatus 112a. The second set of instructions may be indicative of a path to be followed by the second robotic apparatus 112a to reach the operation area 108, an identifier of a target platform (e.g., the operation platform 124a) of the operation platforms 124 that may have been assigned by the control server 114 to receive the inventory item, and one or more operations to be performed by the second robotic apparatus 112a to align the target level with the target platform. The second set of instructions may cause the second robotic apparatus 112a to receive the inventory item from the processing station 120a. The inventory item may be received at the target level of the plurality of levels of the second robotic apparatus 112a. The target level may be a level of the plurality of levels that may have been assigned to receive the inventory item handled at the processing station 120a. The second set of instructions may further cause the second robotic apparatus 112a to transport the received inventory item from the processing station 120a to the operation area 108. The second set of instructions may further cause the second robotic apparatus 112a to identify the target platform (for example, the operation platform 124a) at the operation station 122. The target platform may refer to a shelf, a bin, a storage space, or the like that may be assigned for receiving the inventory item from the second robotic apparatus 112a. Subsequently, the control server 114 may communicate a third set of instructions to the second robotic apparatus 112a. Based on the third set of instructions, the second robotic apparatus 112a may be configured to adjust a height and an orientation of the target level so as to align the target level of the second robotic apparatus 112a with the operation platform 124a, for example, the target platform of the operation station 122. Further, based on the third set of instructions, the second robotic apparatus 112a may be configured to actuate a conveyor of the target level that has the inventory item to transfer the inventory item to the target platform, for example, the operation platform 124a. In some embodiments, the second robotic apparatus 112a may receive the one or more storage bins having the inventory items on the target level. In such embodiments, the second robotic apparatus 112a may transfer the one or more storage bins to the target platform.

In operation, the control server 114 may receive an order fulfillment request associated with one or more inventory items. In accordance with goods-to-person (GTP) system implementation, the control server 114 may be configured to communicate the first set of instructions to the first robotic apparatus 110a. Based on the first set of instructions, the first robotic apparatus 110a may identify the storage unit 118a having the one or more inventory items in the inventory storage area 104. Subsequently, the first robotic apparatus 110a may transport the storage unit 118a from the inventory storage area 104 to the processing station 120a. At the processing station 120a, the operator may perform the first set of pick/put operations for handling the inventory items. The inventory items may be picked from the storage unit 118a and put/placed on the target level of the second robotic apparatus 112a. Further, the control server 114 may communicate the second set of instructions to the second robotic apparatus 112a. Based on the second set of instructions, the second robotic apparatus 112a may be configured to transport the inventory items from the processing station 120a to the operation station 122. Subsequently, the control server 114 may communicate the third set of instructions to the second robotic apparatus 112a. Based on the third set of instructions, the second robotic apparatus 112a may identify the target platform (e.g., the operation platform 124a) and align the target level with the target platform to transfer the inventory items. Further, the second robotic apparatus 112a may actuate the conveyor of the target level having the inventory items. Based on a rotational movement i.e., rotation of the conveyor, the inventory items may be transferred to the target platform, for example, the operation platform 124a.

Although the above description is with regards to a GTP system implementation, the scope of the disclosure is not limited to it. In other embodiments, the storage facility 102 may have a totes-to-person (TTP) system implementation, a manual picking system implementation, or any combination of the GTP system, TTP system, and the manual picking system.

In accordance with a TTP system implementation, the control server 114 may be configured to communicate the first set of instructions to the first robotic apparatus 110a. Based on the first set of instructions, the first robotic apparatus 110a may identify the storage unit 118a having the one or more inventory items stored in the inventory storage area 104. In an embodiment, inventory items in the storage unit 118a may stored in a plurality of totes. Subsequently, the first robotic apparatus 110a may transport the storage unit 118a from the inventory storage area 104 to the processing station 120a. At the processing station 120a, the operator may perform the first set of pick/put operations for handling the inventory items. The inventory items may be picked from the storage unit 118a and put/placed in one or more totes. For example, inventory items pertaining to same order may be put in a same tote. In scenarios where the size of the tote is insufficient to accommodate all inventory items of the same order, the inventory items may be put in multiple totes. Once the inventory items are put in the totes, the totes are then placed on the target level of the second robotic apparatus 112a. Further, the control server 114 may communicate the second set of instructions to the second robotic apparatus 112a. Based on the second set of instructions, the second robotic apparatus 112a may be configured to transport the received totes from the processing station 120a to the operation station 122. Subsequently, the control server 114 may communicate the third set of instructions to the second robotic apparatus 112a. Based on the third set of instructions, the second robotic apparatus 112a may identify the target platform (e.g., the operation platform 124a) and align the target level with the target platform to transfer the received totes. Further, the second robotic apparatus 112a may actuate the conveyor of the target level having the totes. Based on a rotational movement i.e., rotation of the conveyor, the totes may be transferred to the target platform, for example, the operation platform 124a.

In accordance with a manual system implementation, the control server 114 may be configured to communicate the first set of instructions to one or more operators in the inventory storage area 104 to perform various pick/put operations on the one or more inventory items stored in the storage unit 118a. Based on the first set of instructions, the one or more operators may perform the first set of pick/put operations for handling the inventory items. In an embodiment, the inventory items may be picked from the storage unit 118a and put/placed in one or more totes available in the inventory storage area 104. Once the inventory items are put in the totes, the totes are then placed on the target level of the second robotic apparatus 112a available in the inventory storage area 104. In another embodiment, the inventory items may be picked from the storage unit 118a and directly placed on the target level of the second robotic apparatus 112a available in the inventory storage area 104. In yet another embodiment, there may exist another conveying mechanism that connects the inventory storage area 104 and the processing area 106, such that the inventory items picked by the one or more operators from the storage unit 118a are placed on the conveying mechanism, which conveys or transports the inventory items to the processing station 120a in the processing area 106. At the processing station 120a, the operator may perform the pick the inventory items from the conveying mechanism and place the picked inventory items on the target level of the second robotic apparatus 112a. Once the inventory items or the totes with inventory items are placed on the target level of the second robotic apparatus 112a, the control server 114 may communicate the second set of instructions to the second robotic apparatus 112a. Based on the second set of instructions, the second robotic apparatus 112a may be configured to transport the inventory items or the totes from the processing station 120a to the operation station 122. Subsequently, the control server 114 may communicate the third set of instructions to the second robotic apparatus 112a. Based on the third set of instructions, the second robotic apparatus 112a may identify the target platform (e.g., the operation platform 124a) and align the target level with the target platform to transfer the inventory items or the totes. Further, the second robotic apparatus 112a may actuate the conveyor of the target level having the inventory items or the totes. Based on a rotational movement i.e., rotation of the conveyor, the inventory items or the totes may be transferred to the target platform, for example, the operation platform 124a

It will be apparent to a person skilled in the art that the exemplary environment 100 is for illustration purposes and does not limit the scope of the disclosure.

FIG. 2 is a schematic diagram that illustrates a storage unit (for example, the storage unit 118a), in accordance with an exemplary embodiment of the disclosure. Referring to FIG. 2, illustrated is the storage unit 118a. The storage unit 118a may have a plurality of shelves 202a-202d (hereinafter, collectively referred to and designated as “the shelves 202”). The shelves 202 may have different size and shape. Further, the shelves 202 may be configured to store one or more inventory items (for example, a plurality of inventory items 204a-204e). The plurality of inventory items 204a-204e are collectively referred to and designated as “the inventory items 204”. The shelves 202 may be configured to accommodate the inventory items 204 of different sizes, shapes, and weights. The storage unit 118a may have a corresponding resting position in the inventory storage area 104 of the storage facility 102. As shown, the storage unit 118a may be placed on a work floor 206 of the storage facility 102.

It will be apparent to a person skilled in the art that the storage unit 118a is exemplary and does not limit the scope of the disclosure. In other embodiments, the storage unit 118a may have a different structure, count of shelves, dimension of shelves, or the like.

FIG. 3 is a schematic diagram that illustrates the first robotic apparatus 110a, in accordance with an exemplary embodiment of the disclosure. Referring to FIG. 3, shown is the first robotic apparatus 110a used in the storage facility 102 for picking, carrying, and transporting the storage unit 118a from one location to another location within the storage facility 102. The first robotic apparatus 110a may be configured to communicate with the control server 114 via the communication network 116 by using various wired, wireless, or optical communication protocols. In an example, the first robotic apparatus 110a may include a top plate 302 for lifting the storage unit 118a and a control device (not shown) for controlling a movement (i.e., rotational movement and vertical movement) of the corresponding top plate to lift and secure the storage unit 118a.

The first robotic apparatus 110a may be configured to receive the first set of instructions from the control server 114 for transporting the storage unit 118a between the inventory storage area 104 and the processing area 106. The first robotic apparatus 110a may be further configured to secure the storage unit 118a during transportation thereof so that the storage unit 118a does not topple while being transported to the operation area 108. In an embodiment, the first robotic apparatus 110a may include a locking mechanism for securing the storage unit 118a while it gets transported.

It will be apparent to a person skilled in the art that the first robotic apparatus 110a illustrated in FIG. 3 is exemplary and does not limit the scope of the disclosure.

In an embodiment, the plurality of shelves 202a-202d of the storage unit 118a may be movable. In one embodiment, the first robotic apparatus 110a may engage with the storage unit 118a to move the plurality of shelves 202a-202d. Each shelf of the plurality of shelves 202a-202d may be moved to adjust a height of a first shelf of the plurality of shelves 202a-202d so as to make the first shelf accessible to the operator at the processing station 120a. Further, the height of the first shelf may be adjusted to align with the access position of the storage unit 118a. In some embodiments, the storage unit 118a may include an actuator that may move the plurality of shelves 202a-202d to adjust a height of the first shelf of the plurality of shelves 202a-202d according to a height of the operator at the processing station 120a.

FIG. 4 is a schematic diagram that illustrates an exemplary scenario of engagement between the storage unit and the first robotic apparatus, in accordance with an exemplary embodiment of the disclosure. Referring to FIG. 4, shown is an exemplary scenario 400 that illustrates the engagement between the storage unit 118a and the first robotic apparatus 110a. The storage unit 118a may include the plurality of movable shelves (e.g., a plurality of movable shelves 402a-402e). Heights of such movable shelves 402a-402e may be adjustable so as to align each movable shelf 402a-402e with the access position (depicted within a dotted box 404) of the storage unit 118a. The access position 404 may be a portion of the storage unit 118a from where the inventory items stored therein may be accessed by an operator. In an embodiment, the access position 404 may be dynamic in nature and may vary in accordance with height of different operators. In another embodiment, the access position 404 may be a fixed portion of the storage unit 118a that may have an opening for accessing inventory items stored in the storage unit 118a. The access position 404 may be used by the operator for retrieval of the inventory items from the storage unit 118a as well as placement of the inventory items in the storage unit 118a. The storage unit 118a further includes a first drive mechanism (depicted within a dotted box 406) coupled with the plurality of movable shelves 402a-402e. The first drive mechanism 406 may include a first drive medium 408 (e.g., chain drive, belt drive, or the like) and a first plurality of pullies (for example, first and second pullies 410a and 410b). A rotational movement of the first and second pullies 410a and 410b may cause the first drive medium 408 to move in a direction that may be opposite to a direction of rotation of the first and second pullies 410a and 410b. Such movement of the first drive medium 408 may cause the plurality of movable shelves 402a-402e to move from a current position thereof. That is to say, when actuated, the first drive mechanism 406 moves the plurality of movable shelves 402a-402e so as to align at least the first shelf (e.g., the movable shelf 402e) of the plurality of movable shelves 402a-402e with respect to the access position 404. The inventory items that are to be handled may be stored on the first shelf.

In an embodiment, the first drive mechanism 406 may be actuated manually by the operator. In such an embodiment, the height of the first shelf may be adjusted by manually operating the first drive mechanism 406 by the operator. In another embodiment, the first robotic apparatus 110a may receive a fourth set of instructions from the control server 114 to align the first shelf of the plurality of movable shelves 402a-402e with the access position 404 of the storage unit 118a when the first shelf may be out of reach of the operator. The first robotic apparatus 110a may be configured to actuate the first drive mechanism 406 to adjust the height of the first shelf based on the fourth set of instructions received from the control server 114

The first robotic apparatus 110a may include an actuator mechanism, having an external pulley 412, that may be configured to actuate the first drive mechanism 406 based on the fourth set of instructions. The first robotic apparatus 110a may engage the external pulley 412 with the second pulley 410b. Subsequently, the first robotic apparatus 110a may actuate the first drive mechanism 406 by activating the external pulley 412 to move the second pully 410b so as to align the first shelf with the access position 404. Hence, the inventory item stored on the first shelf becomes accessible to the operator. In an example, the first drive medium 408 may be moved in a direction shown by way of arrows due to engagement between the second pulley 410b and the external pulley 412. Such movement of the first drive medium 408 may cause the first shelf (e.g., the shelf 406e) to move towards the access position 404 and align with the access position 404.

It will be apparent to a person skilled in the art that the engagement between the storage unit 118a and the first robotic apparatus 110a is exemplary and does not limit the scope of the disclosure.

FIG. 5 is a schematic diagram that illustrates the second robotic apparatus, in accordance with an exemplary embodiment of the disclosure. The second robotic apparatus 112a may include the plurality of levels (for example, a plurality of levels 502-506) having identical or different dimensions (for example, length, breadth). As shown, each level 502-506 may have different dimensions and hence inventory item(s) of suitable sizes may be placed on each level of the plurality of levels 502-506. Further, each level of the plurality of levels 502-506 includes at least one conveyor that may receive the inventory item to be transported to the operation area 108. As shown, the level 502 may include a first conveyor 508 and a second conveyor 510. A movement of the first and second conveyors 508 and 510 may be mutually independent. Further, the level 504 may include a single conveyor 512. Moreover, a gap between two shelves may be varying. As shown, a first gap G₁ between the level 504 and 506 may be greater than a second gap G₂ between the level 502 and the level 504. Hence, an inventory item to be kept on the level 506 may have a dimension larger than another inventory item being kept on the level 504. A top level (i.e., the level 502) may be used to place an inventory item that may be larger than inventory items being placed on other levels (i.e., levels 504 and 506).

Each level of the plurality of levels 502-506 of the second robotic apparatus 112a may have corresponding physical attributes. The physical attributes may include the count of conveyors of each level of the plurality of levels 502-506, weight bearing capacity of each level of the plurality of levels 502-506, inventory item dimension that could be handled by each level of the plurality of levels 502-506, and size of the conveyor of each level of the plurality of levels 502-506.

The count of conveyors of a level may refer to a number of conveyors at each level of the second robotic apparatus 112a. The count of conveyors at each level may be directly proportional to a count of target platforms to which each level may transfer the inventory items while transporting the inventory items to the operation area 108. The weight bearing capacity of a level may refer to weight of the inventory items that may be carried by the level. The weight bearing capacity of each level may indicate whether the level may carry light-weight or heavy-weight inventory items. In an example, the weight bearing capacity of a level may be 100 kilograms. In such an example, the level may be able to carry heavy-weight inventory items.

The inventory item dimension that could be handled by a level may refer to a size of an inventory item that could be carried by the level. In an embodiment, the inventory item dimension that could be handled by a level may be based on a distance (e.g., gap) between two adjacent levels. Greater the distance between two adjacent levels larger would be the inventory item dimension that could be carried by a lower level of the two adjacent levels.

The size of the conveyor of a level may refer to a dimension (length and breadth) of conveyor(s) of the level. In some embodiments, the level may have a plurality of conveyors. In such embodiments, each conveyor of the plurality of conveyors may have same or different dimensions. The size of the conveyor may be indicative of a size of the inventory items that may be handled by the level.

In an embodiment, the height of each level of the plurality of levels 504-506 of the second robotic apparatus 112a may be adjustable. In such an embodiment, the second robotic apparatus 112a may include a second drive mechanism. The second drive mechanism may be actuated by the second robotic apparatus 112a to adjust the height of each level. The second robotic apparatus 112a may actuate the second drive mechanism based on the third set of instructions received from the control server 114. When actuated, the second drive mechanism moves at least one level of the plurality of levels 502-506. The second drive mechanism may adjust the height of each level by increasing or decreasing a gap/distance between two consecutive levels. For increasing a height of an upper level of the two adjacent levels, a gap between the upper level and a lower level may be increased. For decreasing a height of an upper level of the two adjacent levels, a gap between the upper level and a lower level may be decreased. The second drive mechanism moves at least one level of the plurality of levels 502-506 so as to align the target level with the target platform to transfer the inventory items to the target platform. In an embodiment, the height of each level may be adjusted by changing/adjusting a length of first and second support bars 514 and 516.

The second robotic apparatus 112a may be configured to transport the inventory items between the processing area 106 and the operation area 108. For transporting the inventory items, the second robotic apparatus 112a may receive the inventory items at the target level such that the inventory items may be placed on the top surface of a conveyor of the target level. The second robotic apparatus 112a may transport the inventory items based on the second set of instructions received from the control server 114. Subsequently, based on the third set of instructions received from the control server 114, the second robotic apparatus 112a may be configured to align with the target platform of the operation station 122 to transfer the inventory items to the target platform.

In an embodiment, the second robotic apparatus 112a may transfer the inventory items to the target platform based on a rotation of the conveyor of the target level of the plurality of levels 502-506. In an embodiment, the second robotic apparatus 112a may have inventory items at two levels i.e., the levels 502 and 504 of the plurality of levels 502-506 to be transferred to the same target platform. In such an embodiment, the second robotic apparatus 112a may first align the level 502 with the target platform to transfer one or more inventory items to the target platform. Subsequently, the second robotic apparatus 112a may align the level 504 with the target platform to transfer the remaining inventory items to the target platform by adjusting a height of the level 504 in accordance with the target platform. Based on alignment of the levels 502 and 504 with the target platform, the second robotic apparatus 112a may actuate corresponding conveyor(s) to transfer the inventory items to the target platform.

In an embodiment, the second robotic apparatus 112a may have inventory items at two levels i.e., the levels 502 and 504 of the plurality of levels 502-506 to be transferred to different target platforms, for example, a first target platform and a second target platform, respectively. In such an embodiment, the second robotic apparatus 112a may first align the level 502 with the first target platform to transfer corresponding inventory items to the first target platform. Subsequently, the second robotic apparatus 112a may align the level 504 with the second target platform to transfer corresponding inventory items to the second target platform. Based on alignment of the levels 502 and 504 with the first and second target platforms respectively, the second robotic apparatus 112a may actuate corresponding conveyor(s) to transfer the inventory items to the corresponding first and second target platforms. In some embodiments, the second robotic apparatus 112a may be configured to actuate multiple conveyers of different levels concurrently to execute concurrent transfer of multiple inventory items to corresponding target platforms.

It will be apparent to a person of ordinary skill in the art that the second robotic apparatus 112a shown in FIG. 5 is exemplary and does not limit the scope of the disclosure. In other embodiments, the second robotic apparatus 112a may include additional or fewer levels.

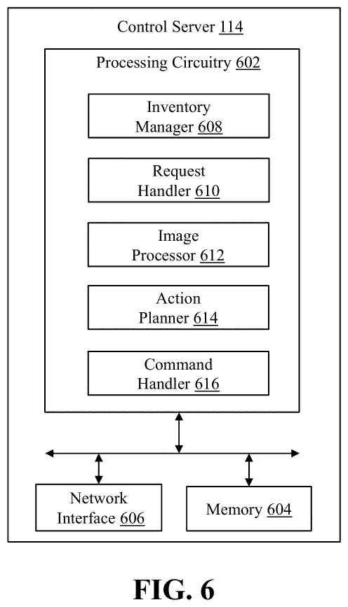

FIG. 6 is a block diagram that illustrates the control server, in accordance with an exemplary embodiment of the disclosure. The control server 114 includes a processing circuitry 602, a memory 604, and a network interface 606. The processing circuitry 602 includes an inventory manager 608, a request handler 610, an image processor 612, an action planner 614, and a command handler 616. It will be apparent to a person having ordinary skill in the art that the control server 114 is for illustrative purposes and not limited to any specific combination of hardware circuitry and/or software.

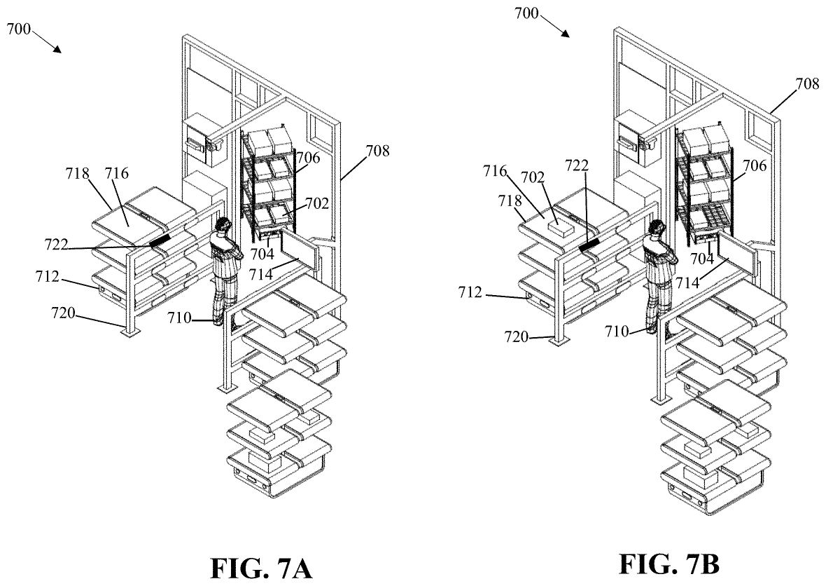

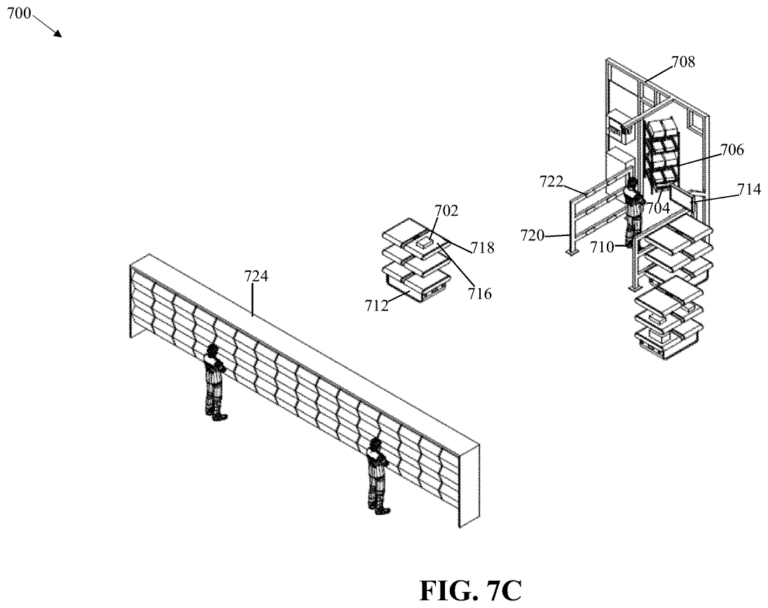

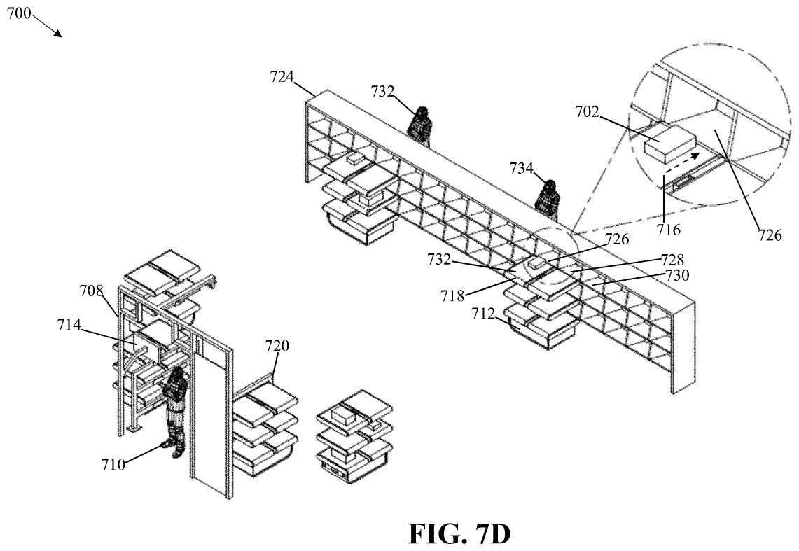

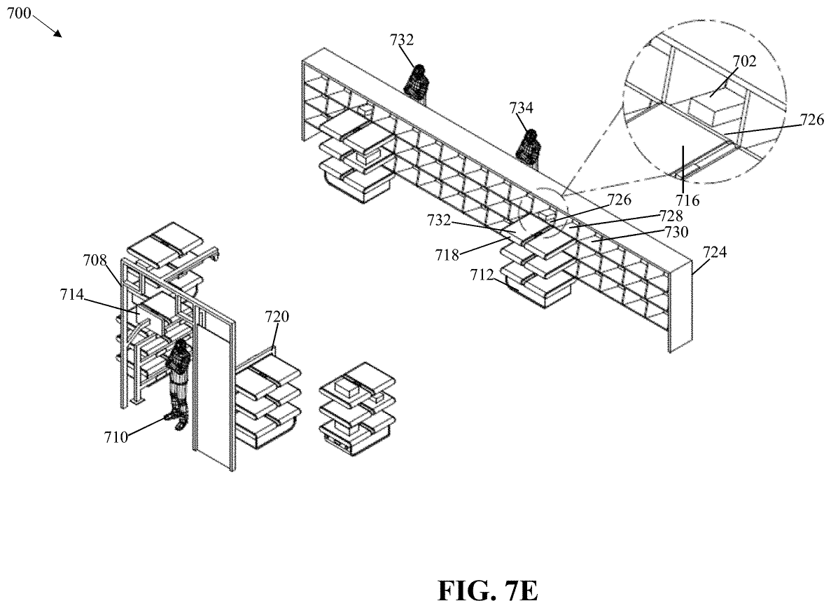

The processing circuitry 602 may execute various operations, such as inventory or warehouse management operations, procurement operations, or the like. The processing circuitry 602 may execute the inventory management operations, such as planning a sequence of actions to be performed by the first robotic apparatus 110a and the second robotic apparatus 112a for handling inventory items (as described in conjunction with FIGS. 7A-7E) and to facilitate transportation of the inventory items within the storage facility 102. The sequence of actions may include actions including one or more movement, alignment, height adjustment, or the like to be performed by the first robotic apparatus 110a and the second robotic apparatus 112a for handling the inventory items. The processing circuitry 602 may execute the inventory or warehouse management operations by way of the inventory manager 608, the request handler 610, the image processor 612, the action planner 614, and the command handler 616.

The inventory manager 608 includes suitable logic, instructions, circuitry, interfaces, and/or code for managing an inventory list that includes a list of inventory items stored in the storage facility 102, a number of units of each inventory item stored in the storage facility 102, and a source location (i.e., a shelf and/or a storage unit) where inventory items are stored. For example, the inventory manager 608 may add new inventory items to the inventory list when the new inventory items are stored in the storage facility 102 and may update the inventory list whenever there is any change in regards to the inventory items stored in the storage facility 102 (e.g., when items are retrieved from the storage units 118 for fulfillment of orders).

The request handler 610 includes suitable logic, instructions, circuitry, interfaces, and/or code for processing all handling requests received by the control server 114. The request handler 610 may identify inventory items pertinent to the handling requests, and the storage units 118 that store the inventory items associated with the handling requests. The request handler 610 may further communicate, for fulfillment of the handling requests, details regarding the inventory items (such as the source location, the destination location, the fiducial markers, the unique identifiers, or the like) to the first robotic apparatus 110a and the second robotic apparatus 112a. Additionally, the request handler 610 may merge various handling requests when inventory items to be handled are stored in same storage unit.

The image processor 612 includes suitable logic, instructions, circuitry, interfaces, and/or code for receiving data from one or more optical sensors deployed in the storage facility 102. By utilizing one or more image processing techniques on the data received from one or more optical sensors, the image processor 612 may detect dimensions, alignment, and position of one or more inventory items to be handled or placed on the target level or the target platform.

The action planner 614 includes suitable logic, instructions, circuitry, interfaces, and/or code for planning various actions to be performed by the first robotic apparatus 110a and the second robotic apparatus 112a. For example, the action planner 614 may plan the sequence of actions to be performed by the first robotic apparatus 110a and the second robotic apparatus 112a to handle the inventory items. The control server 114 may plan the sequence of actions in real-time based on data of the inventory items that are to be handled, and the historical data. The action planner 614 also executes various other operations such as determining whether orientation of the second robotic apparatus 112a with respect to the target platform is accurate to receive the inventory items, generating one or more instructions for handling the inventory items, or the like. The action planner 614 may further store a planned sequence of actions in the memory 604 for future use, e.g., handling the inventory items.

The command handler 616 includes suitable logic, instructions, circuitry, interfaces, and/or code for generating various commands corresponding to the sequence of actions planned by the action planner 614. For example, the command handler 616 may generate one or more sets of commands corresponding to one or more actions in a sequence of actions for handling the inventory items.

Examples of the inventory manager 608, the request handler 610, the image processor 612, the action planner 614, and the command handler 616 may include, but are not limited to, an application-specific integrated circuit (ASIC) processor, a reduced instruction set computing (RISC) processor, a complex instruction set computing (CISC) processor, a field-programmable gate array (FPGA), a microcontroller, a combination of a central processing unit (CPU) and a graphics processing unit (GPU), or the like.

The memory 604 includes suitable logic, instructions, circuitry, interfaces to store one or more instructions that are executed by the inventory manager 608, the request handler 610, the image processor 612, the action planner 614, and the command handler 616 for performing one or more operations. Additionally, the memory 604 may store the inventory list, the virtual map or the layout of the storage facility 102, or the like. Examples of the memory 604 may include a RAM, a ROM, a removable storage drive, an HDD, a flash memory, a solid-state memory, and the like.

The network interface 606 transmits and receives data over the communication network 116 using one or more communication network protocols. The network interface 606 may transmit various messages and commands to the first robotic apparatus 110a and the second robotic apparatus 112a and receive data from the one or more optical sensors deployed in the storage facility 102. Examples of the network interface 606 may include, but are not limited to, an antenna, a radio frequency transceiver, a wireless transceiver, a Bluetooth transceiver, an ethernet based transceiver, a universal serial bus (USB) transceiver, or any other device configured to transmit and receive data.

FIGS. 7A-7E are schematic diagrams that illustrate an exemplary scenario 700 of implementation of an automated inventory management system, in accordance with an exemplary embodiment of the disclosure. Referring to FIG. 7A, the control server 114 may receive a handling request associated with an inventory item 702. The inventory item 702 may be stored in the inventory storage area 104 and may be required to be transported and handled in the processing area 106 and subsequently transported to the operation area 108 for fulfillment of the handling request.

The control server 114 may identify a first robotic apparatus 704 from the first robotic apparatus 110 that may be available to transport a storage unit 706 having the required inventory item 702 from the inventory storage area 104 to the processing area 106. The storage unit 706 may be similar to the storage unit 118a of FIG. 2 or FIG. 4. The control server 114 may be configured to identify the inventory item 702 required for fulfillment of the handling request and the storage unit 706 that may have the inventory item 702 stored therein. Subsequently, the control server 114 may communicate the first set of instructions to the first robotic apparatus 704. The first set of instructions may be indicative of the storage unit 706, a path to reach the storage unit 706 in the inventory storage area 104, and a path to be followed by the first robotic apparatus 704 to reach from the inventory storage area 104 to a processing station 708 where the inventory item 702 is to be handled for fulfilment of the handling request. Further, the first set of instructions may be indicative of a shelf of the storage unit 706 that may have the inventory item 702.

The first robotic apparatus 704 may transport, based on the received first set of instructions, the storage unit 706 from the inventory storage area 104 to the processing station 708 in the processing area 106. In some embodiments, based on the first set of instructions, the first robotic apparatus 704 may actuate a first drive mechanism of the storage unit 706 to align the shelf having the inventory item 702 with an access position of the storage unit 706 to make the inventory item 702 accessible to an operator 710 of the processing station 708.

Subsequently, the control server 114 may identify a second robotic apparatus 712 that may be available for transporting the inventory item 702 from the processing station 708 to the operation area 108. The control server 114 may render, via a user interface 714, information (position, shape, size, weight, or the like) associated with the inventory item 702 that is to be handled at the processing station 708. The first set of pick/put operations for handling the inventory item 702 may be performed by the operator 710 associated with the processing station 708. The first set of pick/put operations may include picking of the inventory item 702 from a corresponding shelf of the storage unit 706 and putting the inventory item 702 on a target level 718 of the second robotic apparatus 712. In an embodiment, the target level 718 may be identified by the operator 710 based on information presented via the user interface 714. In another embodiment, the target level 718 may be randomly selected by the operator 710 for a first item associated with the handling request. Subsequently, the inventory item 702 may be placed on a conveyor 716 of the target level 718. In such an embodiment, remaining inventory items associated with the handling request may be placed at the same conveyor or at different conveyors of the same level (for example, the target level 718). In such embodiments, the control server 114 may identify the target level 718 selected by the operator 710 and may indicate the target level 718 by way of visual indicators indicative. In an embodiment, the control server 114 may be configured to identify the target level 718 based on one or more attributes associated with at least one of the target level 718, a target platform, the inventory item 702. The one or more attributes may include a height of the target level 718, a height of the target platform, a weight of the inventory item 702, a size of the inventory item 702, or the like. In an example, the target level 718 may be selected by the control server 114 as the height of the target level 718 may match to the height of the target platform.

The user interface 714 may further present information for placing the inventory item 702 on the conveyor 716 of the target level 718 of the second robotic apparatus 712. The second robotic apparatus 712 may be one of the second robotic apparatus 112. In an embodiment, the processing station 708 may include a pick/put to light (PPTL) device 720 having one or more visual indicators for indicating the target level 718. The PPTL device 720 may be a fixed or movable structure that may align with the second robotic apparatus 712 to indicate the target level 718 of the plurality of levels of the second robotic apparatus 712 where the inventory item 702 is to be placed. The PPTL device 720 may indicate the target level 718 by way of a visual and/or audio indicator. As shown, the PPTL device 720 may be aligned with the second robotic apparatus 712 and a visual indicator 722 of the PPTL device 720 may indicate the target level 718. In another example, an indicator corresponding to the target level 718 may vibrate or generate an audio sound optionally accompanied by a visual indication to indicate the target level 718. In an embodiment, the PPTL device 720 may include a plurality of light emitting diodes (LEDs) as the visual indicators. Each light emitting diode (LED) of the plurality of LEDs may be configured to glow for providing visual indications. Further, the plurality of LEDs may exhibit different colors while glowing for different indications. In an example, an LED may exhibit yellow color to indicate that corresponding level of the second robotic apparatus 712 may be a target level. In another example, the LED may exhibit red color to indicate an incorrect placement of inventory item 702 on the target level 718 and/or an incorrect inventory item being placed on the target level. In another example, the LED may exhibit green color to indicate a correct placement of the inventory item 702 on the target level 718 and/or a correct inventory item being placed on the target level.

In an embodiment, the PPTL device 720 may be integral to the second robotic apparatus 712, without deviating from the scope of disclosure. In such an embodiment, the second robotic apparatus 712 may include one or more audio/visual indicators at each level and/or in correspondence with each conveyor at each level. Such audio/visual indicators may indicate the target level 718 and/or the conveyor 716 at which the inventory item 702 is to be placed.

Referring to FIG. 7B, the inventory item 702 may have been identified by the operator 710 based on the information rendered via the user interface 714. Subsequently, based on visual indication provided by the visual indicator 722, the target level 718 may be identified by the operator 710. Subsequently, the inventory item 702 may be placed on a top surface of the conveyor 716 of the target level 718 by way of the first set of pick/put operations performed by the operator 710. Further, the second robotic apparatus 712 and/or the control server 114 may determine a correct placement of the inventory item 702 on the target level 718. The second robotic apparatus 712 and/or the control server 114 may determine the correct placement based on one of one or more images or videos captured by one or more optical sensors deployed at the processing station 708, a weight of the inventory item 702, or the like.

Referring to FIG. 7C, the control server 114 may communicate the second set of instructions to the second robotic apparatus 712 based on determination of the correct placement of the inventory item 702 on the conveyor 716 of the target level 718. The second set of instructions may be indicative of a path to be followed by the second robotic apparatus 712 to reach an operation station 724 and an identifier associated with a target platform to which the inventory item 702 is to be transferred. Based on the second set of instructions, the second robotic apparatus 712 may be configured to transport the inventory item 702 from the processing station 708 to the operation station 724. Referring to FIG. 7D, the operation station 724 may include one or more operation platforms (for example, operation platforms 726, 728, and 730). The second robotic apparatus 712 may be further configured to identify, based on the second set of instructions, the target platform (e.g., the operation platform 726) for transferring the inventory item 702. In an embodiment, the second robotic apparatus 712 may identify the target platform (e.g., the operation platform 726) based on its identifier, an audio or visual indicator associated with the target platform (e.g., the operation platform 726), fiducial marker associated with location of the target platform, or the like.

The control server 114 may determine a correct alignment between the second robotic apparatus 712 and the target platform (e.g., the operation platform 726) based on one or more images or videos captured by one or more optical sensors deployed in the operation area 108. Further, the control server 114 may determine one or more operations and/or height adjustments to be performed by the second robotic apparatus 712 to attain the correct alignment with the operation platform 726. Subsequently, the control server 114 may be configured to communicate the third set of instructions to the second robotic apparatus 712. The third set of instructions may be indicative of the one or more operations and/or height adjustments to be performed by the second robotic apparatus 712 to attain the correct alignment with the operation platform 726.

Further, the second robotic apparatus 712, based on the third set of instructions, may perform change in position, orientation, and height of the target level 718 so as to align the second robotic apparatus 712 with the operation platform 726. In other words, the second robotic apparatus 712 may change/adjust its position, orientation, and the height of the target level 718 to align the target level 718 with the operation platform 726.

In an embodiment, the second drive mechanism of the second robotic apparatus 712 may include a second plurality of pullies and a second drive medium. The second plurality of pullies and the second drive medium may be controlled by the control server 114 based on the third set of instructions so that the target level 718 may be aligned with the operation platform 726.

In an embodiment, the control server 114 may determine the correct alignment of the second robotic apparatus 712 with the operation platform 726 (target platform) based on the one or more images or videos captured by the optical sensors deployed at the operation station 724. In an instance, the alignment of the second robotic apparatus 712 with the operation platform 726 may not be correct. In such an instance, the control server 114 may communicate a new set of instructions to the second robotic apparatus 712. The new set of instructions may be followed by the second robotic apparatus 712 to attain the correct alignment with the operation platform 726.

Upon attaining the correct alignment of the second robotic apparatus 712 with the operation platform 726, the second robotic apparatus 712 may initiate rotation (as shown by a dotted arrow) of the conveyor 716 of the target level 718 having the inventory item 702 based on the third set of instructions. As shown in FIG. 7E, based on the rotation of the conveyor 716, the inventory item 702 may get transferred from the conveyor 716 to the operation platform 726 (e.g., target platform). Further, based on a successful transfer of the inventory item 702 to the operation platform 726, the conveyor 716 may stop rotating.

In an embodiment, the successful transfer of the inventory item 702 to the operation platform 726 may be determined by the control server 114 based on one or more images or videos captured by the one or more optical sensors deployed in the operation area 108. In an instance, the control server 114 may determine, based on the one or more images or videos captured by the optical sensors, that the inventory item 702 may not be successfully transferred and/or correctly placed on the operation platform 726. In such an instance, the control server 114 may communicate one or more instructions to the second robotic apparatus 712 to ensure the successful transfer and/or correct placement of the inventory item 702 on the operation platform 726. The control server 114 may alternatively or additionally communicate one or more instructions to one or more operators (for example, first and second operators 732 and 734) associated the operation station 724. The one or more instructions may be communicated to the first and second operators 732 and 734 by way of corresponding display devices (for example, a wearable display device, a cellphone, or the like). Based on the instructions displayed via the display devices one of the first and second operators 732 and 734 may correct the placement and/or execute the transfer of the inventory item 702 from the conveyor 716 to the operation platform 726.

In an embodiment, the second robotic apparatus 712 may be further configured to transport at least one new inventory item from the operation area 108 to the processing area 106 based on a fifth set of instructions. The fifth set of instructions may be indicative of a path to be followed by the second robotic apparatus 712 to reach the processing station 708 from the operation area 108. The fifth set of instructions may also include one or more instructions for adjusting the height of one or more levels of the plurality of levels of the second robotic apparatus 712. The height of the one or more levels of the plurality of levels may be adjusted so as to make the new inventory item accessible to the operator 710 associated with the processing station 708. The second robotic apparatus 712 may transport the new inventory item to the processing area 106 for execution of a second set of pick/put operations. The new inventory item may be transported to the processing area 106 for handling of the new inventory item. The second set of pick/put operations may be executed for handling the new inventory item for replenishment of inventory within the storage facility 102. The second set of pick/put operations may include picking of the new inventory item from the second robotic apparatus 712 and putting the new inventory item on the storage unit 706.

In an embodiment, the first robotic apparatus 704 may be further configured to transport the storage unit 706 from the processing area 106 to the inventory storage area 104 based on the first set of instructions communicated by the control server 114. In such an embodiment, the storage unit 706 may be transported to its resting position in the inventory storage area 104. The storage unit 706 may include inventory items that may be stored in the storage unit 706 and may not be required for fulfilment of the handling request. The storage unit 706 may also include the new inventory item to be stored in the inventory storage area 104. The first robotic apparatus 704 may transport the storage unit 706 from the processing area 106 to the inventory storage area 104 after the first set of pick/put operations are executed on the inventory item 702 to be handled in the processing area 106.

In an embodiment, the control server 114 may be configured to communicate a sixth set of instructions to the first robotic apparatus 704 to transport the storage unit 706 to the inventory storage area 104. The sixth set of instructions may be indicative a path to be followed by the first robotic apparatus 704 to transport the storage unit 706 to its resting position in the inventory storage area 104.

It will be apparent to a person skilled in the art that implementation of the inventory management system described in conjunction with FIGS. 7A-7E is exemplary and does not limit the scope of the disclosure.

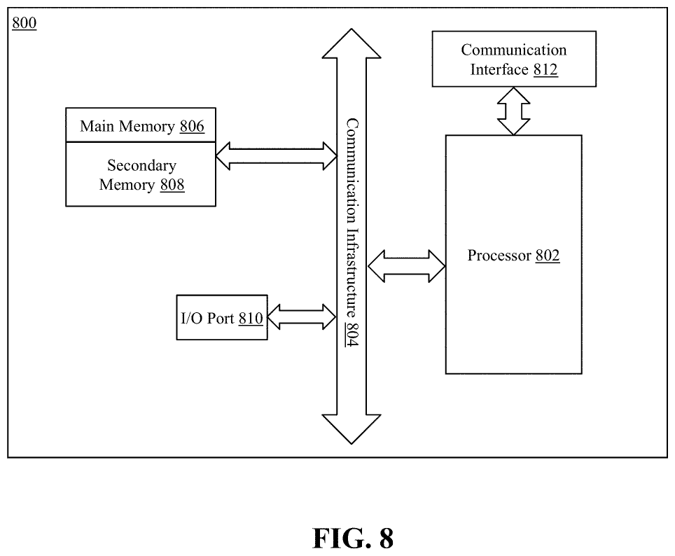

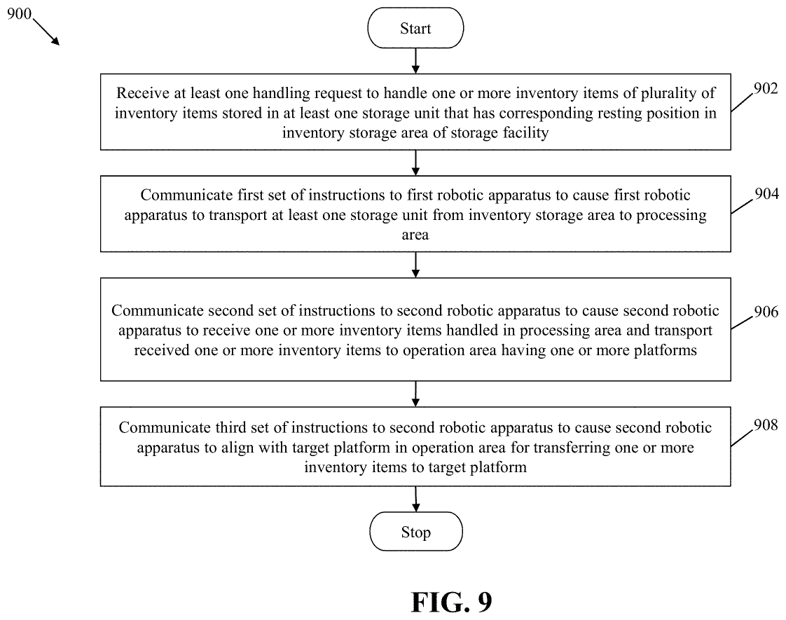

FIG. 8 is a block diagram that illustrates a system architecture of a computer system 800 for inventory management, in accordance with an exemplary embodiment of the disclosure. An embodiment of the disclosure, or portions thereof, may be implemented as computer readable code on the computer system 800. In one example, the control server 114 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the method of FIG. 9.

The computer system 800 may include a processor 802 that may be a special purpose or a general-purpose processing device. The processor 802 may be a single processor or multiple processors. The processor 802 may have one or more processor “cores.” Further, the processor 802 may be coupled to a communication infrastructure 804, such as a bus, a bridge, a message queue, the communication network 116, multi-core message-passing scheme, or the like. The computer system 800 may further include a main memory 806 and a secondary memory 808. Examples of the main memory 806 may include RAM, ROM, and the like. The secondary memory 808 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer readable recording media.

The computer system 800 may further include an input/output (I/O) port 810 and a communication interface 812. The I/O port 810 may include various input and output devices that are configured to communicate with the processor 802. Examples of the input devices may include a keyboard, a mouse, a joystick, a touchscreen, a microphone, and the like. Examples of the output devices may include a display screen, a speaker, headphones, and the like. The communication interface 812 may be configured to allow data to be transferred between the computer system 800 and various devices that are communicatively coupled to the computer system 800. Examples of the communication interface 812 may include a modem, a network interface, i.e., an Ethernet card, a communication port, and the like. Data transferred via the communication interface 812 may be signals, such as electronic, electromagnetic, optical, or other signals as will be apparent to a person skilled in the art. The signals may travel via a communications channel, such as the communication network 116, which may be configured to transmit the signals to the various devices that are communicatively coupled to the computer system 800. Examples of the communication channel may include a wired, wireless, and/or optical medium such as cable, fiber optics, a phone line, a cellular phone link, a radio frequency link, and the like. The main memory 806 and the secondary memory 808 may refer to non-transitory computer readable mediums that may provide data that enables the computer system 800 to implement the method illustrated in FIG. 9.

FIG. 9 is a flowchart that illustrates a process for inventory management, in accordance with an exemplary embodiment of the disclosure. FIG. 9 is described in conjunction with elements of FIG. 1. Referring to FIG. 9 illustrated is the method 900 for inventory management. The process may generally start at 902, the handling request for handling the inventory items stored in the storage unit 118a is received. The control server 114 may be configured to receive the handling request for handling the inventory item stored in the storage unit 118a. The storage unit 118a may have corresponding resting position in the inventory storage area 104 of the storage facility 102.

The process proceeds to 904, where the first set of instructions is communicated to the first robotic apparatus 110a to cause the first robotic apparatus 110a to transport the storage unit 118a between the inventory storage area 104 and the processing area 106 of the storage facility 102. The control server 114 may be configured to communicate the first set of instructions to the first robotic apparatus 110a to cause the first robotic apparatus 110a to transport the storage unit 118a between the inventory storage area 104 and the processing area 106 of the storage facility 102. The first set of pick/put operations is executed in the processing area 106 to handle the inventory item.

The process proceeds to 906, where the second set of instructions may be communicated to the second robotic apparatus 112a to cause the second robotic apparatus 112a to transport the handled inventory items from the processing area 106 to the operation area 108 of the storage facility 102. The control server 114 may be configured to communicate the second set of instructions to the second robotic apparatus 112a to cause the second robotic apparatus 112a to transport the handled inventory item from the processing area 106 to the operation area 108 of the storage facility 102. The operation area 108 may have one or more platforms to receive the inventory item transported by the second robotic apparatus 112a. The inventory item is transported from the processing area 106 to the operation area 108 by the second robotic apparatus 112a based on the second set of instructions.

The process proceeds to 908, where the third set of instructions may be communicated to the second robotic apparatus 112a to cause the second robotic apparatus 112a to align with the target platform in the operation area 108 for transferring the transported the inventory item to the target platform. The control server 114 may be further configured to communicate the third set of instructions to the second robotic apparatus 112a to cause the second robotic apparatus 112a to align with the target platform in the operation area 108 for transferring the transported the inventory item to the target platform.

The disclosed embodiments encompass numerous advantages. Exemplary advantages of the disclosed methods include, but are not limited to, automated inventory management in a GTP system implementation, a TTP system implementation, a manual picking system implementation, or a combination thereof. The disclosed methods and systems significantly reduce manual intervention requirement during handling of the inventory items in the storage facilities, for example, the disclosed methods and systems offer a no-walk solution for the storage facility 102 where operators are not required to move from one location to another for any operation. Therefore, the disclosed methods and systems significantly reduce a time required for processing an order. Consequently, the disclosed methods and systems increase the throughput of the storage facility 102. Also, the disclosed methods and systems allow for adjustment in height of selves of the storage units 118 and the levels of the second robotic apparatus 112 so as to make the levels and the shelves accessible to the operators. Hence, the disclosed methods and systems significantly reduce inconvenience caused to operators of the storage facility 102. The disclosed methods and systems significantly reduce a probability of human errors being caused during processing of orders. The inventory management system and method provide for no-walk inventory management and hence significantly reduce a probability of accidents. The disclosed methods and systems enable automated handling of inventory items without having to make any significant change to existing infrastructure of the storage facility 102. Hence, the disclosed methods and systems are cost-efficient and provide an optimal solution for hassle-free handling of the inventory items.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the disclosure provide, among other features, systems and methods for inventory management. While various exemplary embodiments of the disclosed systems and methods have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. An inventory management system, comprising:
at least one storage unit that stores a plurality of inventory items and has a corresponding resting position in an inventory storage area of a storage facility;
a first robotic apparatus that is remotely controllable to transport the at least one storage unit between the inventory storage area and a processing area of the storage facility, wherein a first set of pick/put operations are executed in the processing area to handle one or more inventory items of the plurality of inventory items;
a second robotic apparatus that is remotely controllable to transport the handled one or more inventory items between the processing area and an operation area, wherein the operation area has one or more platforms to receive the one or more inventory items transported by the second robotic apparatus; and
a control server that is in communication with the first robotic apparatus and the second robotic apparatus, and configured to:
receive at least one handling request for handling the one or more inventory items;
communicate a first set of instructions to the first robotic apparatus to cause the first robotic apparatus to transport the at least one storage unit that has the one or more inventory items stored therein from the inventory storage area to the processing area, wherein the first robotic apparatus is configured to transport the at least one storage unit from the inventory storage area to the processing area based on the first set of instructions;
communicate a second set of instructions to the second robotic apparatus to cause the second robotic apparatus to receive the one or more inventory items handled in the processing area and transport the received one or more inventory items to the operation area, wherein based on the second set of instructions, the second robotic apparatus is configured to transport the one or more inventory items to the operation area and identify at least one target platform from the one or more platforms of the operation area to transfer the one or more inventory items; and
communicate a third set of instructions to the second robotic apparatus to cause the second robotic apparatus to align with the identified at least one target platform to transfer the transported one or more inventory items to the identified at least one target platform.

2. The inventory management system of claim 1, wherein the at least one storage unit includes a plurality of shelves that store the plurality of inventory items.

3. The inventory management system of claim 2, wherein a height of each shelf of the plurality of shelves of the at least one storage unit is adjustable so as to align each shelf with an access position of the at least one storage unit.

4. The inventory management system of claim 3, wherein the first robotic apparatus is further configured to adjust a height of a first shelf of the plurality of shelves so as to align the first shelf with the access position based on the first set of instructions, and wherein the one or more inventory items that are to be handled are stored on the first shelf.

5. The inventory management system of claim 3, wherein the at least one storage unit further includes a first drive mechanism coupled with the plurality of shelves, and wherein when actuated, the first drive mechanism moves the plurality of shelves so as to align at least a first shelf of the plurality of shelves with respect to the access position.

6. The inventory management system of claim 5, wherein the first robotic apparatus is further configured to actuate the first drive mechanism based on the first set of instructions, and wherein the first robotic apparatus includes an actuator mechanism that is configured to actuate the first drive mechanism based on the first set of instructions.

7. The inventory management system of claim 1, wherein the second robotic apparatus includes a plurality of levels, and wherein each level of the plurality of levels includes at least one conveyor, and wherein the one or more inventory items are received by the second robotic apparatus on a top surface of a conveyor of a target level of the plurality of levels of the second robotic apparatus.

8. The inventory management system of claim 7, wherein the processing area further includes a plurality of visual indicators that when aligned with the plurality of levels of the second robotic apparatus are configured to provide a visual indication of the target level of the plurality of levels at which the one or more inventory items are to be received by the second robotic apparatus.

9. The inventory management system of claim 7, wherein the one or more inventory items are received by the at least one target platform based on a rotation of the conveyor of the target level.

10. The inventory management system of claim 7, wherein a height of each level of the plurality of levels of the second robotic apparatus is adjustable so as to align the target level with the at least one target platform to transfer the one or more inventory items to the at least one target platform.

11. The inventory management system of claim 7, wherein each level of the plurality of levels of the second robotic apparatus has corresponding physical attributes, wherein the physical attributes include a count of conveyor, weight bearing capacity, inventory item dimension that could be handled, size of the conveyor, of each level of the plurality of levels.

12. The inventory management system of claim 10, wherein the second robotic apparatus further includes a second drive mechanism coupled to the plurality of levels, and wherein when actuated, the second drive mechanism moves the plurality of levels so as to align the target level with the at least one target platform to transfer the one or more inventory items to the at least one target platform.

13. The inventory management system of claim 1, wherein the first robotic apparatus is further configured to transport the at least one storage unit from the processing area to the inventory storage area based on the first set of instructions, and wherein the first robotic apparatus transports the at least one storage unit from the processing area to the inventory storage area after the first set of pick/put operations are executed on the one or more inventory items at the processing area.

14. The inventory management system of claim 1, wherein the second robotic apparatus is further configured to transport at least one new inventory item from the operation area to the processing area based on a fourth set of instructions, and wherein the second robotic apparatus transports the at least one new inventory item to the processing area for execution of a second set of pick/put operations for handling the at least one new inventory item.

15. The inventory management system of claim 1, wherein the operation area is one of a defective item collection area, an order consolidation area, a quality check area, and the inventory storage area.

16. A method for inventory management, comprising:
receiving, by a control server in a storage facility, at least one handling request for handling one or more inventory items of a plurality of inventory items stored in at least one storage unit, wherein the at least one storage unit has a resting position in an inventory storage area of the storage facility;
communicating, by the control server, a first set of instructions to a first robotic apparatus to cause the first robotic apparatus to transport the at least one storage unit between the inventory storage area and a processing area of the storage facility, wherein based on the first set of instructions the at least one storage unit is transported from the inventory storage area to the processing area by the first robotic apparatus, and wherein a set of pick/put operations are executed in the processing area to handle the one or more inventory items;
communicating, by the control server, a second set of instructions to a second robotic apparatus to cause the second robotic apparatus to transport the handled one or more inventory items from the processing area to an operation area of the storage facility, wherein the operation area has one or more platforms to receive the one or more inventory items transported by the second robotic apparatus, wherein based on the second set of instructions, the one or more inventory items are transported from the processing area to the operation area by the second robotic apparatus; and
communicating, by the control server, a third set of instructions to the second robotic apparatus to cause the second robotic apparatus to align with a target platform of the one or more platforms in the operation area for transferring the transported one or more inventory items to the target platform.

17. The method of claim 16, wherein the plurality of inventory items are stored on a plurality of shelves of the at least one storage unit, and wherein a height of each shelf of the plurality of shelves is adjustable so as to align each shelf with an access position of the at least one storage unit.

18. The method of claim 17, wherein based on the first set of instructions, a height of a first shelf of the plurality of shelves of the at least one storage unit is adjusted by the first robotic apparatus so as to align the first shelf with respect to the access position, and wherein the one or more inventory items that are to be handled are stored on the first shelf.

19. The method of claim 16, wherein based on the third set of instructions, a height of each level of a plurality of levels of the second robotic apparatus is adjusted so as to align a target level of the plurality of levels with the target platform to transfer the one or more inventory items to the target platform.

20. The method of claim 19, wherein the target platform receives the one or more inventory items from the second robotic apparatus based on a rotation of a conveyor of the target level.
